(19) United States
(12) Patent Application Publication
(10) Pub. No.: US 2011/0091343 A1
(43) Pub. Date: Apr. 21, 2011

(54) DRILL MOTOR ASSEBLY

(76) Inventor: Geoffrey Frederick Archer, Lincolnshire (GB)

(21) Appl. No.: 12/736,534

(22) PCT Filed: Apr. 17, 2009
(86) PCT No.: PCT/GB2009/000984

§ 371 Date: Dec. 28, 2010

(30) Foreign Application Priority Data
Apr. 17, 2008 (GB) 0807008.8

(51) Int. Cl. F01C 1/02; C04B 35/622

(52) U.S. Cl. 418/61.3; 264/112

(57) ABSTRACT

A stator for use with a drill rotor, the stator formed at least in part by a ceramic and/or cermet reinforced alloy material.

The present invention relates to generally to drill motor assemblies and in particular, although not exclusively, to helicoidal motors for use in down-hole drilling, and in particular to the manufacture of the rotors and/or stators of such a motor.

In order to enable the drilling of high temperature oil pockets, typical temperatures in this case are above 250° C., it is essential to utilise high temperature materials for the construction of the in line helicoidal motors. This essentially means that both the rotor and the stator have to be manufactured from materials that will operate in the conditions found in such situations.

We have devised an inventive process of net-shape manufacture capable of producing a surface finish on the internal surfaces of the stator ideally suited to help optimise high load metal on metal sliding contact conditions. This enables the rotor to be made of a suitable metal and/or metal matrix composite. The combination of such a metal-based stator and rotor is novel and inventive.

In accordance with one embodiment of the invention, in line stators by using the net-shape powder metallurgy route, to enable the use of ceramic and cermet reinforced nickel based super alloys or similar high temperature alloys that are combined/reinforced with ceramic or cermet particulate, which can loosely be called metal matrix composites. These material and component combinations cannot be manufactured economically and/or satisfactorily in the conventional way; for example via machines utilising cutting and/or electrical machining techniques.

Net-shape manufacture, or near net-shape manufacture, includes production techniques in which the initial production of the item is very close to or substantially that of, the final (net) shape. This means that very little, if indeed any, finishing work is required. Preferably, in production of the stator, metal powder/particulate is urged against a precision-formed graphite former by isostatic pressure. This consolidates the powder material. The former preferably comprises a boron nitrite coating which serves to filter out, or regulate, ingress of carbon from the former into the stator during the consolidation process.

According to a first aspect of the invention there is provided a stator for use with a drill motor, the stator formed at least in part by a ceramic and/or cermet reinforced alloy material.

According to a second aspect of the invention there is provided a method of manufacturing a stator for use with a drill rotor, the method comprising using material comprising ceramic and/or cermet material and alloy material.

According to a third aspect of the invention there is provided a rotor and stator assembly for a drill motor assembly comprising a stator and a rotor, the stator comprises ceramic and/or cermet reinforced alloy material and the rotor is formed at least in part of a metallic material.

According to a fourth aspect of the invention there is provided a stator and rotor assembly for a drill motor assembly comprising a stator and rotor, at least one of the stator and the rotor comprises a moveable contact surface portion, the moveable contact surface portion arranged to form a seal to be formed between opposing contact surfaces of the stator or the rotor, respectively, the moveable contact surface portion arranged to be capable of movement relative to the stator, where the surface portion is mounted in the stator, and for movement relative to the rotor where the surface portion is mounted in the rotor.

The surface topographical conditions of the rotor and/or stator are important, but may not be essential, in the initial start up conditions enabling the ‘drilling mud’ to be effectively used to lubricate the metal on metal couple during a running in period. Certain topographical features may also be added to the surface of the rotor to facilitate the ‘running in’ of the wear couple.

The use of a high temperature cermet/ceramic reinforced nickel based super alloy for the stator enables it to be used at temperatures in excess of 250° C. It is therefore desirable to ensure the rotor will work at a similar temperature. A variety of materials can be used for the rotor typically but not exclusively hot work die steel.

The combination of degradation mechanisms found in this environment is complex and the synergistic interactions thereby present add to the complexity of resolution. It has been demonstrated that the combination of cermet/ceramic reinforced nickel based super alloys for the stators combined with metallic based rotors enable an appropriate/suitable surface contact couple for this application.

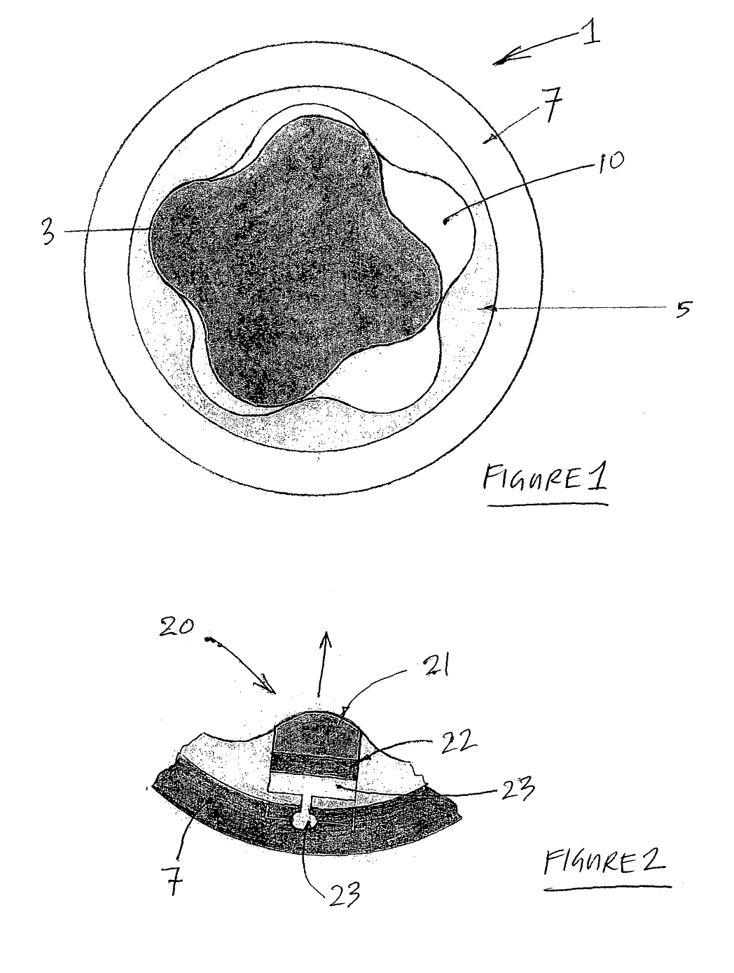

FIG. 1 shows a cross-sectional view of one embodiment of the invention, given by way of example only. FIG. 1 shows a stator and rotor assembly 1 for a down-hole drill water assembly. The assembly 1 comprises a four lobe rotor 3 and a five lobe stator 5. The rotor 3, in use, is arranged to rotate within the stator 5 and a seal is formed at the nip between opposing contact surfaces of the stator and rotor. The stator 5 is made of ceramic and/or cermet reinforced nickel based alloy material. The rotor is also made of a metallic based material. The stator 5 is surrounded by a backing component 7, and the stator 5 defines a bore, or rotor receiving space 10, in which the rotor 3 rotates. It will be appreciated that both the rotor, stator are of elongate form.

Ideally, but not essentially, an oxidising self glazing mechanism should be encouraged on the counter faces to enable a satisfactory wear couple to be established.

This provides the situation of a metal on metal stator rotor combined with surface topography condition resulting in an oxidative wear/running condition.

The rotor maybe manufactured with flutes and/or working surfaces manufactured from a fluro-polymer material. Polymers of this type can typically work at temperature up to and in excess of 300° C. and are suited to this application.

The surface of the ‘net-shape’ stator is there-again very suited for this wear couple

In addition to the above the contact parts of the internal rotor insert, as described above, are made to move via hydraulic pressure utilising the pumped high pressure drilling mud. The purpose of this movement is to enable a seal to be formed between the stator and rotor. This is beneficial to maintain the long term efficiency of the motor.

When a polymer and elastomer rotors and stators are used it is normal for there to be an interference of nominally 0.5 mm to enable a satisfactory seal to be formed. We can utilise hydraulic pressure to move a fluro-polymer/metallic rotor insert on to the surface of the stator effectively to make this seal.

The hydraulic force can be but not restricted to the adoption of multiple or single hydraulic pistons along the length of the insert.

Under normal circumstances there is one more lobe in the stator than is present on the rotor. In this aspect of the invention it is intended that all of the rotor lobes be hydraulically assisted.

FIG. 2 shows a partial cross-sectional view of an alternative arrangement comprising a piston arrangement 20 which forms a moveable contact surface portion of the stator 5. The embodiment shown in FIG. 2 is essentially a modified embodiment of that shown in FIG. 1, in which like features are shown by like reference numerals. The piston arrangement 20 comprises an insert portion 21 made of a fluro-polymer material, a metallic piston component 22 and a hydraulic cavity 23 fitted with hydraulic fluid. The hydraulic fluid pressurises the piston component 22 so as to urge the component outwardly, as shown by the arrow. In use, this advantageously means wear is compensated for. In a further embodiment both stator and rotor may be provided with respective moveable contact surface portions.

1. A stator for use with a drill rotor, the stator formed at least in part by a ceramic and/or cermet reinforced alloy material.

2. A stator as claimed in claim 1 in which the reinforced alloy material provides a contact surface for the rotor.

3. A stator as claimed in claim 1 in which the contact surface is a bore defining surface.

4. A stator as claimed in claim 1 produced by a net-shape manufacturing process.

5. A stator as claimed in claim 1 in which the reinforced alloy material comprises a nickel based alloy material.

6. A stator as claimed in claim 1 for use in down-hole drilling.

7. A method of manufacturing a stator for use with a drill rotor, the method comprising using material comprising ceramic and/or cermet material and alloy material.

8. A method as claimed in claim 7 comprising a net-shape manufacturing process.

9. A method as claimed in claim 7 which comprises consolidating the material, in powder form, against a former.

10. A method as claimed in claim 10 in which the former comprises a boron nitrite coating.

11. A stator and rotor assembly for a drill motor assembly comprising a stator and a rotor, the stator comprises ceramic and/or cermet reinforced alloy material, and the rotor is formed at least in part of a metallic material.

12. A stator and rotor assembly for a drilling motor assembly comprising a stator and rotor, at least one of the stator and the rotor comprises a moveable contact surface portion, the moveable contact surface portion arranged to form a seal to be formed between an opposing surface of the stator or the rotor, respectively, the moveable contact surface portion arranged to be capable of movement relative to the stator, where the surface portion is mounted in the stator, and for movement relative to the rotor where the surface portion is mounted in the rotor.

13. An assembly as claimed in claim 12 which comprises a pressurisation arrangement to urge the moveable contact surface portion towards the opposing surface with which a seal is formed.

14. An assembly as claimed in claim 13 in which the pressurisation arrangement comprises a hydraulic pressurisation arrangement.

15. An assembly as claimed in claim 12 in which the moveable contact surface portion comprises a fluro-polymer material.

16. An assembly as claimed in claim 12 in which the moveable contact surface portion is in the form of a piston.
